(19) United States
(12) Patent Application Publication
(10) Pub. No.: US 2006/0152596 A1
(43) Pub. Date: Jul. 13, 2006

(54) Noise cleaning sparsely populated color digital images

(75) Inventors: James E. Adams JR., Rochester, NY (US); John F. Hamilton JR., Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/032,903

(22) Filed: Jan. 11, 2005

(51) Int. Cl. H04N 5/228

(52) U.S. Cl. 348/222.1

(57) ABSTRACT

A method of noise-cleaning an original sparsely populated color digital image, includes producing a luminance digital image from the original sparsely populated color digital image; producing from the original sparsely populated color digital image at least one sparsely populated chrominance digital image with a resolution lower than the luminance digital image; noise-cleaning the luminance digital image and each digital chrominance image; and producing a noise cleaned sparsely populated color digital image from the noise cleaned luminance and chrominance image(s).

### FIELD OF INVENTION

The invention relates generally to the field of digital image processing, and in particular to noise reduction in sparsely populated color digital images.

### BACKGROUND OF THE INVENTION

Digital cameras capture image data generally through the use a single sensor that consists of a two-dimensional array of individual light detection units called pixels. To record the full-color information about the scene, the pixels are partitioned into three or four different groups with each group being covered by a particular color filter from a set of color primaries. Perhaps the most popular set of color primaries currently used in this regard is red-green-blue (RGB). The corresponding most popular arrangement of RGB color filters upon the sensor is the so-called Bayer pattern (FIG. 9). This pattern is tessellated over the entire surface of the sensor so that every pixel is either a red, green, or blue pixel.

As a consequence of using such a color filter array (CFA), the raw data received from the sensor consist of three separate color channels, or planes, that are sampled at less than the full resolution of the sensor's pixel array. It is usually the task of the subsequent image processing chain of operations to produce an image consisting of three, full-resolution, fully-processed color channels. One of the component image processing operations is noise cleaning, or noise reduction.

Once a three-channel, full-color image has been produce from the original raw sensor image data, then any number of existing noise reduction methods can be applied to the image data. The full-color representation of the image is well known and well studied in the field of image processing. However, single-plane raw CFA sensor image data is a representation that is unique to digital cameras and does not have same a similarly established body of knowledge.

There are a number of described technologies that address noise cleaning CFA image data. These all fall into the category of directly cleaning the raw RGB image data as produced by the sensor. In U.S. Pat. No. 6,625,325, Gindele et al. teach noise-cleaning the CFA image data with the use of anisotropic noise reduction kernels that are responsive to the image details within a pixel neighborhood. In U.S. Pat. No. 6,229,578, Acharya, et al. describe noise-cleaning CFA image data with the use of directional low-pass (blur) kernels that are responsive to the edges in a pixel neighborhood. In U.S. Patent Application Publication 2003/0091232, Kalevo, et al., reveal noise-cleaning CFA image data using directional blur kernels that are also responsive to edges in a pixel neighborhood. While Acharya, et al. do not mix CFA pixel values of different colors to drive their directional processing, Kalevo, et al., use differences between adjacent pixels of different CFA colors to guide their directional processing.

It is well known that there are distinct advantages to noise-cleaning an image not in an RGB color space, but, instead, in a luminance-chrominance color space. This alternate image representation permits the separate processing of the spatially important luminance image information and the chromatically important chrominance image information. For example, in a luminance-chrominance representation, aggressive noise cleaning can be performed on the chrominance channels without affecting the important high-frequency edge and texture detailed contained in the luminance channel. Unfortunately, CFA image data does not contain full-resolution data for each color channel, so a direct transform from raw sensor RGB to luminance-chrominance is not possible. So, the benefits of a luminance-chrominance noise cleaning approach to CFA image data are not directly available.

### SUMMARY OF THE INVENTION

The object of this invention is to provide a noise cleaning method for sparsely populated color images.

This object is achieved in a method of noise-cleaning an original sparsely populated color digital image, comprising:

(a) producing a luminance digital image from the original sparsely populated color digital image;

(b) producing from the original sparsely populated color digital image at least one sparsely populated chrominance digital image with a resolution lower than the luminance digital image;

(c) noise-cleaning the luminance digital image and each digital chrominance image; and

(d) producing a noise cleaned sparsely populated color digital image from the noise cleaned luminance and chrominance image(s).

It is a feature of the present invention to provide a computationally efficient way to reduce noise in the luminance and chrominance components of sparsely populated color digital images.

It has been found that by decomposing original sparsely populated color digital images into luminance and chrominance images and then noise-reducing each of them significant improvements can be made in noise reduction.

Another feature of the invention is that it provides a way to perform CFA image data noise cleaning that has the same advantages and results as noise-cleaning the data in luminance-chrominance space.

### BRIEF DESCRIPTION OF THE DRAWINGS

FIG. 1 is a schematic of a computer system for practicing the present invention;

FIG. 2 is a block diagram of the sequence of operations comprising the present invention;

FIG. 3 depicts a directional median filter neighborhood of pixels;

FIG. 4 depicts two adjacent green interpolation pixel neighborhoods;

FIG. 5 depicts a directional median filter neighborhood of pixels;

FIG. 6 depicts a directional blur filter neighborhood of pixels;

FIG. 7 is a block diagram of a chrominance channel blurring operation in accordance with the present invention;

FIG. 8 is a block diagram of a noise cleaning of pyramid image components operation in accordance with the present invention; and

FIG. 9 depicts the basic pattern of colored pixels comprising the Bayer CFA pattern.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware and/or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such as a personal computer. Consequently, the computer system will not be discussed in detail herein. It is also instructive to note that the images are either directly input into the computer system (for example by a digital camera) or digitized before input into the computer system (for example by scanning an original, such as a silver halide film).

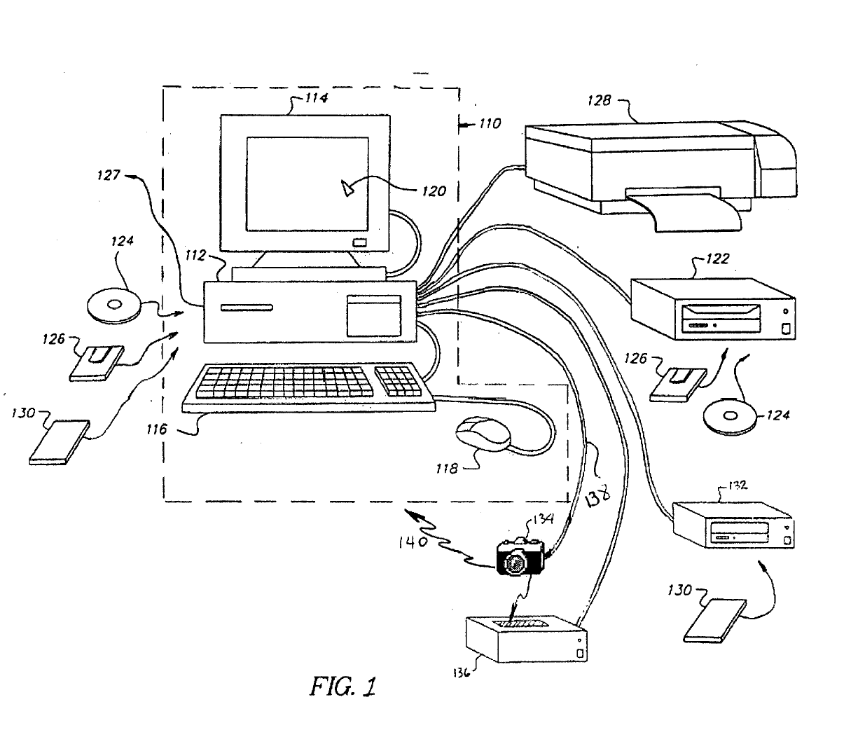

Referring to FIG. 1, there is illustrated a computer system 110 for implementing the present invention. Although the computer system 110 is shown for the purpose of illustrating a preferred embodiment, the present invention is not limited to the computer system 110 shown, but can be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 can be used for moving a selector 120 on the display 114 and for selecting an item on which the selector 120 overlays, as is well known in the art.

A compact disk-read only memory (CD-ROM) 124, which typically includes software programs, is inserted into the microprocessor based unit 112 for providing a means of inputting the software programs and other information to the microprocessor based unit 112. In addition, a floppy disk 126 can also include a software program, and is inserted into the microprocessor-based unit 112 for inputting the software program. The CD-ROM 124 or the floppy disk 126 can alternatively be inserted into externally located disk drive unit 122 which is connected to the microprocessor-based unit 112. Still further, the microprocessor-based unit 112 can be programmed, as is well known in the art, for storing the software program internally. The microprocessor-based unit 112 can also have a network connection 127, such as a telephone line, to an external network, such as a local area network or the Internet. A printer 128 can also be connected to the microprocessor-based unit 112 for printing a hardcopy of the output from the computer system 110.

Images can also be displayed on the display 114 via a personal computer card (PC card) 130, such as, as it was formerly known, a PCMCIA card (based on the specifications of the Personal Computer Memory Card International Association) which contains digitized images electronically embodied in the card 130. The PC card 130 is ultimately inserted into the microprocessor based unit 112 for permitting visual display of the image on the display 114. Alternatively, the PC card 130 can be inserted into an externally located PC card reader 132 connected to the microprocessor-based unit 112. Images can also be input via the CD-ROM 124, the floppy disk 126, or the network connection 127. Any images stored in the PC card 130, the floppy disk 126 or the CD-ROM 124, or input through the network connection 127, can have been obtained from a variety of sources, such as a digital camera (not shown) or a scanner (not shown). Images can also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, an algorithm can be stored in any of the storage devices heretofore mentioned and applied to images in order to noise reduce the images.

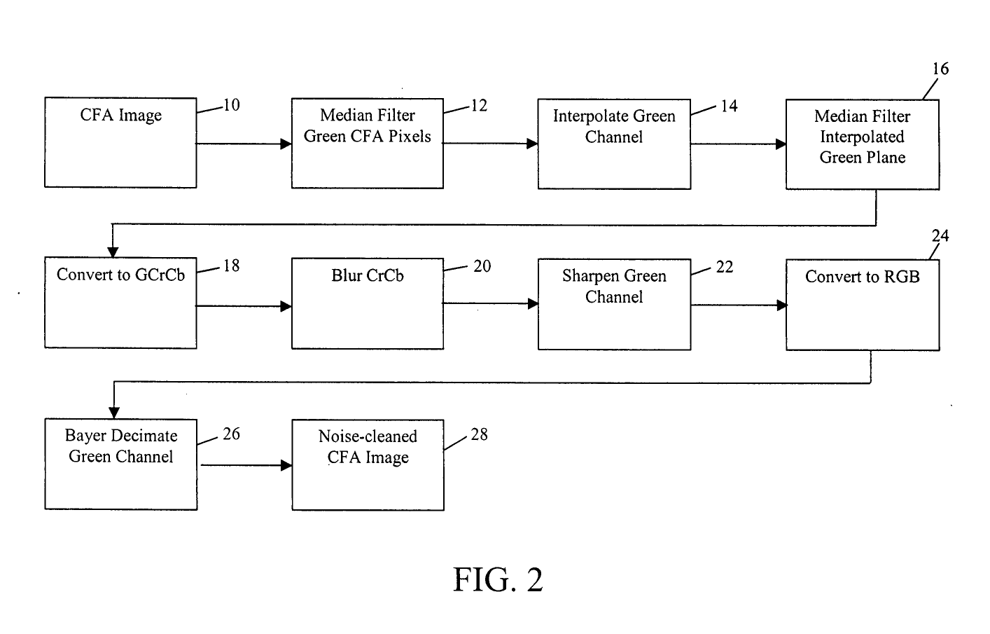

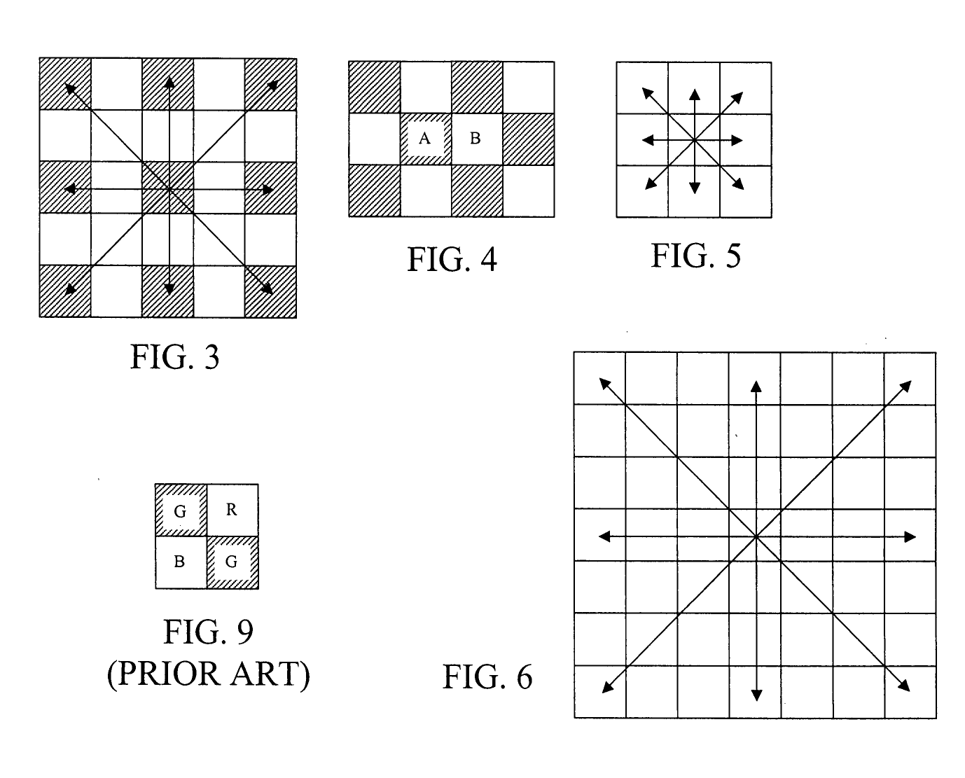

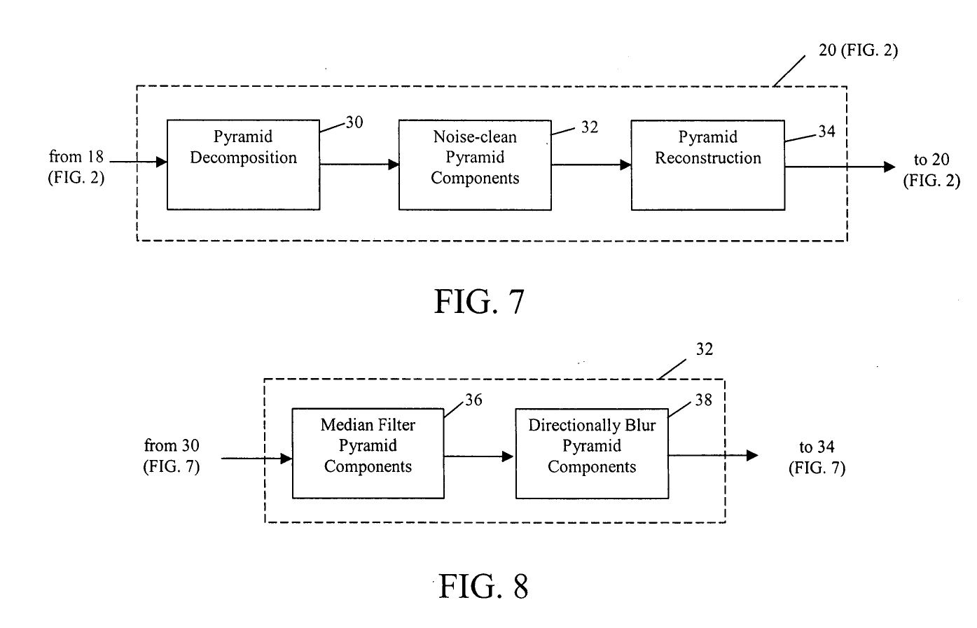

Referring to FIG. 2, block 10 represents the original color filter array (CFA) image. In the preferred embodiment it is assumed that the data in the image is arranged in the CFA pattern of FIG. 9, the so-called Bayer pattern. However, it should be clear to one schooled in the art that this invention can be used with other RGB CFA patterns. The first operation is to median filter the green pixels 12 (FIG. 2) of the CFA image. FIG. 3 shows the pixel neighborhood that is used for this median filtering operation. Each shaded pixel in FIG. 3 is a green pixel and the central shaded pixel is the pixel to be filtered. Median values are computed for four 3×1 pixel neighborhoods, as indicated by the arrows in FIG. 3. The pixel value of the central green pixel is replaced with the median value closest to the original pixel value of the central green pixel.

Returning to FIG. 2, the next operation is to interpolate the green channel 14 to produce estimates for the missing green pixel values. FIG. 4 shows two adjacent pixel neighborhoods used in this interpolation operation. Each shaded pixel in FIG. 4 is a green pixel. It is assumed that the green pixel values of the non-green (unshaded) pixels have been initially set to zero. The entire green channel is convolved with the following convolution kernel:

$$\frac{1}{8} ( \begin{matrix}1 & 2 & 1 \\ 2 & 4 & 2 \\ 1 & 2 & 1\end{matrix} )$$

In the case of the neighborhood centered on pixel A in FIG. 4, this operation will noise-clean the existing green pixel value for pixel A. In the case of the neighborhood centered on pixel B in FIG. 4, this operation will provide an estimate for the missing green pixel value for pixel B.

Returning to FIG. 2, the next operation is to median filter the interpolated green channel 16. FIG. 5 shows the pixel neighborhood used for this filtering operation. At this point, all of the pixels in FIG. 5 have green pixel values. Similar to the process of block 12, median green pixel values are computed for four 3×1 pixel neighborhoods, as indicated by the arrows in FIG. 5. The green pixel value of the central pixel is replaced with the median value closest to the original green pixel value of the central pixel.

Returning to FIG. 2, the next operation is to convert the CFA image from an RGB color metric to a GCrCb color metric 18. Each red pixel value is converted to a Cr value by the following expression:
Cr=(R−G)/2
where R is the red pixel value and G is the green pixel value for a given red pixel location. Each blue pixel value is converted to a Cb value by the following expression:
Cb=(B−G)/2
where B is the blue pixel value and G is the green pixel value for a given blue pixel location.

After block 18 is complete, the resulting Cr and Cb values are blurred 20. FIG. 7 shows a detailed diagram of block 20. The Cr and Cb channels are decomposed (block 30) into standard Laplacian pyramid representations consisting each of six base images and five residual images. Refer to commonly assigned U.S. patent application Ser. No. 10/738,658 filed Dec. 17, 2003, entitled “Noise Reduction in Color Digital Images Using Pyramid Decomposition” by Adams et al, for a detailed description of such a pyramid decomposition process, the disclosure of which is incorporated herein by reference. The pyramid image components are then noise-cleaned 32. FIG. 8 shows a detailed diagram of block 32. The residual images and the lowest resolution base image are first median filtered (block 36) in a manner analogous to that employed in block 16, FIG. 2. Next, the three highest resolution residuals image are directionally blurred 38. FIG. 6 shows the pixel neighborhood used in block 38. Blurred Cr and Cb values are computed for each of the four 7×1 pixel neighborhoods indicated by the arrows in FIG. 6. (FIG. 6 represents either the Cr plane with green and blue pixel locations removed, or the Cb plane with green and red pixel locations removed.) The blurring kernel used for this operation is

$$\frac{1}{64} ( \begin{matrix}5 & 8 & 12 & 14 & 12 & 8 & 5 )\end{matrix}$$

Additionally, a classifier value is computed for each 7×1 pixel neighborhood using the following kernel:

$$\frac{1}{64} ( \begin{matrix}- 5 & - 8 & - 12 & 50 & - 12 & - 8 & - 5 )\end{matrix}$$

The Cr and Cb values in the center of the FIG. 6 pixel neighborhood are replaced with the blurred 7×1 values corresponding to the neighborhood with the smallest absolute classifier value.

Returning to FIG. 7, the noise-cleaned pyramid components are used to reconstruction a full resolution image with blurred CrCb values 34. This is a standard Laplacian pyramid reconstruction. Refer to above-cited U.S. patent application Ser. No. 10/738,658 for a detailed description of this process.

Returning to FIG. 2, the green channel is now sharpened 22. This is accomplished by convolving the green channel with the following kernel:

$$\frac{1}{24} ( \begin{matrix}- 1 & 0 & - 1 & 0 & - 1 \\ 0 & 0 & 0 & 0 & 0 \\ - 1 & 0 & 32 & 0 & - 1 \\ 0 & 0 & 0 & 0 & 0 \\ - 1 & 0 & - 1 & 0 & - 1\end{matrix} )$$

The sharpening operation is followed by a conversion of GCrCb values back to RGB 24. Each Cr value is converted with the following expression:
R=2Cr+G
and each Cb value is converted with the following expression:
B=2Cb+G

The final step is to convert the image back into CFA image format using Bayer decimation 26. This is accomplished by discarding the interpolated green pixel values so that each resulting pixel in the image consists of either a green pixel value, a red pixel value, or a blue pixel value. As discussed previously, the resulting image data will be represented as shown in FIG. 9. The result of this process is a noise-cleaned CFA image 28, FIG. 2.

The noise reduction algorithm disclosed in the preferred embodiment of the present invention can be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that can be used as a processing unit, a display unit, or a unit to give processing instructions), and as a service offered via the World Wide Web.

In each case, the algorithm can stand alone or can be a component of a larger system solution. Furthermore, the interfaces with the algorithm, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the algorithm itself can be fully automatic, can have user input (be fully or partially manual), can have user or operator review to accept/reject the result, or can be assisted by metadata (metadata that can be user supplied, supplied by a measuring device (e.g. in a camera), or determined by an algorithm). Moreover, the algorithm can interface with a variety of workflow user interface schemes.

The algorithm disclosed herein in accordance with the invention can have interior components that utilize various data detection and reduction techniques (e.g., face detection, eye detection, skin detection, flash detection).

A computer program product can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations and modifications can be effected within the spirit and scope of the invention.

### PARTS LIST

10 CFA Image
12 Median Filter Green CFA Pixels Operation
14 Interpolate Green Channel Operation
16 Median Filter Interpolated Green Plane Operation
18 Convert to GCrCb Operation
20 Blur CrCb Operation
22 Sharpen Green Channel Operation
24 Convert to RGB Operation
26 Bayer Decimate Green Channel Operation
28 Noise-cleaned CFA Image
30 Pyramid Decomposition Operation
32 Noise-clean Pyramid Components Operation
34 Pyramid Reconstruction Operation
36 Median Filter Pyramid Components Operation
38 Directionally Blur Pyramid Components Operation
110 Computer System
112 Microprocessor-based Unit
114 Display
116 Keyboard
118 Mouse
120 Selector on Display
122 Disk Drive Unit
124 Compact Disk-read Only Memory (CD-ROM)
126 Floppy Disk
127 Network Connection
128 Printer
130 Personal Computer Card (PC card)
132 PC Card Reader
134 Digital Camera
136 Camera Docking Port
138 Cable Connection
140 Wireless Connection

1. A method of noise-cleaning an original sparsely populated color digital image, comprising:
(a) producing a luminance digital image from the original sparsely populated color digital image;
(b) producing from the original sparsely populated color digital image at least one sparsely populated chrominance digital image with a resolution lower than the luminance digital image;
(c) noise-cleaning the luminance digital image and each digital chrominance image; and
(d) producing a noise cleaned sparsely populated color digital image from the noise cleaned luminance and chrominance image(s).

2. The method of claim 1 wherein the chrominance image(s) are produced from color differences between the luminance image and the original sparsely populated color digital image.

3. The method of claim 1 wherein the luminance image noise cleaning includes using directional median filters.

4. The method of claim 1 wherein the chrominance image noise cleaning includes using directional blur kernels.

5. A method for processing an original sparsely populated color digital image provided by a color filter array of a digital camera having colored pixels to produce a noise cleaned sparsely populated color digital image, comprising:
(a) producing a luminance digital image from the original sparsely populated color digital image;
(b) producing from the original sparsely populated color digital image at least one sparsely populated chrominance digital image with a resolution lower than the luminance digital image;
(c) noise-cleaning at least one of chrominance digital images; and
(d) producing a noise cleaned sparsely populated color digital image from the luminance and noise cleaned chrominance image(s).

6. The method of claim 5 wherein the chrominance image(s) are produced from color differences between the luminance image and the original sparsely populated color digital image.

7. The method of claim 5 wherein the chrominance image noise cleaning includes using directional blur kernels.

8. A method for processing an original sparsely populated color digital image provided by a color filter array of a digital camera having colored pixels to produce a noise cleaned sparsely populated color digital image, comprising:
(a) producing a luminance digital image from the original sparsely populated color digital image;
(b) producing from the original sparsely populated color digital image at least one sparsely populated chrominance digital image with a resolution lower than the luminance digital image;
(c) noise-cleaning the luminance digital image; and
(d) producing a noise cleaned sparsely populated color digital image from the noise cleaned luminance and chrominance image(s).

9. The method of claim 8 wherein the chrominance image(s) are produced from color differences between the luminance image and the original sparsely populated color digital image.

10. The method of claim 8 wherein the luminance image noise cleaning includes using directional median filters.
